(19) United States
(12) Patent Application Publication
(10) Pub. No.: US 2007/0074293 A1
(43) Pub. Date: Mar. 29, 2007

(54) Communication apparatus, system for transmitting and receiving content, and method for managing content list of the communication apparatus

(76) Inventor: Chikara Ushimaru, Hamura-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/529,333

(22) Filed: Sep. 29, 2006

(30) Foreign Application Priority Data
Sep. 29, 2005 (JP) 2005-284077

(51) Int. Cl. H04N 7/16; H04L 9/00; G06F 12/14; H04L 9/32; G06F 17/30; G06F 11/30; G06F 7/04; G06K 9/00; H03M 1/68; H04K 1/00

(52) U.S. Cl. 726/26; 713/169; 713/165; 713/167; 713/193; 713/176

(57) ABSTRACT

According to one embodiment, a communication apparatus includes a storage unit configured to store content including attribute information indicating presence or absence of copyright protection and a list showing a table of the content, an authentication key exchange unit configured to mutually obtain authentication keys identifying mutual devices to and from other communication apparatus to authenticate the other communication apparatus, a protected content movement unit configured to stop reception of new authentication by the exchange unit when copyright protected content is selected from the list, and to encrypt the selected and copyright protected content by using the authentication keys and moving it to the other communication apparatus authenticated by the exchange unit via a network, and a content list management unit configured to delete the copyright protected content from the table of the list during content movement by the movement unit.

### CROSS-REFERENCE TO RELATED APPLICATIONS

This application is based upon and claims the benefit of priority from Japanese Patent Application No. 2005-284077, filed Sep. 29, 2005, the entire contents of which are incorporated herein by reference.

### BACKGROUND

1. Field

One embodiment of the invention relates to an operation control technique of a communication apparatus for transmitting and receiving a variety of content including copyright protected content via a network.

2. Description of the Related Art

In recent years, network integration for so-called digital household electronic apparatuses such as HDD recorders and digital television (TV) apparatuses has been developed. To deal with such a situation, working out of a guideline for transmitting and receiving content among household electronic apparatuses has been progressing under the auspices of a standardization organizations such as the Digital Living Network Alliance (DLNA) (refer to http://www.dlna.org).

Recently, transmission and reception of copyright protected contents via Internet Protocol (IP) have been started and Digital Transmission Content Protection (DTCP)-IP has been adopted widely as one content protection technique (refer to http://www.dtcp.com).

For instance, for viewing content such as movies stored in the HDD recorder through a digital TV apparatus, according to a procedure based on the DLNA, the TV apparatus firstly refers to a content list in the HDD recorder. The content list showing a list of all content stored in the HDD recorder, a user appropriately selects content desired to be viewed by itself.

If the selected content is a copyright protected one, the user needs encryption to transmit and receive the content via the network. DTCP-IP performs authentication key exchange processing between a transmission side apparatus (source device) and a reception side apparatus (sink device) to execute encryption and decryption by using the authentication key obtained in the authentication key exchange processing.

Copying the copyright protected content being prohibited, when the storing place of the protected content is changed, a process referred to as “MOVE” (movement) is conducted. A movement source deletes the content at the same time of its transmission, so that this transmission admits of no failure. Therefore, during the execution of the “MOVE” (movement), the DTCP-IP limits the treatment of the copyright protected content only for the content in the “MOVE” (movement) not to accept any new authentication key exchange processing to and from other apparatuses.

By the way, it is presumed, for instance, that the digital TV apparatus refers to the content list in an HDD recorder (HDD recorder in transmitting copy protected content to PC) in performing the “MOVE” (movement) to and from a PC, and also selects copyright protected content from the content list. In this case, although the authentication key exchange processing is required to encrypt and decrypt the selected content, the HDD recorder does not accept new authentication key exchange processing. As for a user of the TV apparatus, who does not know the “MOVE” (movement) to and from the PC, there is possibility of misunderstanding that as if the authentication key exchange processing itself has ended in failure owing to any trouble.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary view showing a configuration of a system for transmitting and receiving content regarding an embodiment of the present invention;

FIG. 2 is an exemplary timing chart showing an operation flow of an HDD recorder, a PC and a digital TV apparatus regarding the embodiment;

FIG. 3 is an exemplary block diagram showing a configuration related to authentication processing failure prevention during “MOVE” (movement) of the HDD recorder regarding the embodiment;

FIGS. 4A and 4B are exemplary views for explaining effects of update of content lists to be executed by the HDD recorder regarding the embodiment;

FIG. 5 is an exemplary flowchart showing an operation procedure of the HDD recorder regarding the embodiment;

FIG. 6 is an exemplary block diagram showing a configuration of a digital TV apparatus related to a modification of the system for transmitting and receiving the content regarding the embodiment; and

FIG. 7 is an exemplary view for explaining a modification update of the content list in the system for transmitting and receiving the content regarding the embodiment.

### DETAILED DESCRIPTION

Various embodiments according to the invention will be described hereinafter with reference to the accompanying drawings. In general, according to one embodiment of the invention, a communication apparatus includes a storage unit configured to store content including attribute information indicating presence or absence of copyright protection and a list showing a table of the content, an authentication key exchange unit configured to mutually obtain authentication keys identifying mutual devices to and from other communication apparatus to authenticate the other communication apparatus, a protected content movement unit configured to stop reception of new authentication by the exchange unit when copyright protected content is selected from the list, and to encrypt the selected and copyright protected content by using the authentication keys and moving it to the other communication apparatus authenticated by the exchange unit via a network, and a content list management unit configured to delete the copyright protected content from the table of the list during content movement by the movement unit.

FIG. 1 is the exemplary view showing the configuration of the system for transmitting and receiving the content regarding the embodiment of the invention.

A HDD recorder 1, a personal computer (PC) 3a and a digital TV apparatus 3b are each DTCP-IP-compliant apparatuses including functions of transmitting and receiving content through routers 2 via an expandable IP network. The HDD recorder 1 operates as a Source device storing a variety of content, and the PC 3a and digital TV apparatus 3b operate as Sink devices using the contents in the HDD recorder 1.

The PC 3a and digital TV apparatus 3b that are the Sink devices firstly request, to the HDD recorder 1 that is the Source device, for transmissions of content lists each showing content lists stored in the HDD recorder 1. Upon obtaining the content lists, the PC 3a and digital TV apparatus 3b perform menu displays setting all content in the content lists as selectable choices to request for transmissions of selected and instructed content from among the choices to the HDD recorder 1.

Each content includes attribute information indicating the presence or absence of the copyright protection, and in the case that the selected content is a copyright protected one, the PC 3a that is the Sink device performs authentication key exchange processing with the HDD recorder 1 that is the Source device. Then, in transmitting and receiving the content via the IP network, the HDD recorder 1 encrypts the content by using the authentication keys which have been obtained mutually and the PC 3a and digital TV apparatus 3b decrypt it.

When the “MOVE” (movement) of one of the copy protected content stored in the HDD recorder 1, for example, to the PC 3a, the HDD recorder 1 becomes to reject an acceptance of the authentication key exchange processing to and from other apparatuses, more specifically, the digital TV apparatus 3b after the “MOVE” (movement).

That is, during performing “MOVE” (movement) between the HDD recorder 1 and the PC 3a, the digital TV apparatus 3b cannot utilize the copyright protected content stored in the HDD recorder 1, and also results in failure in the authentication key exchange processing. Therefore, during “MOVE” (movement), for instance, to and from the PC 3a, the HDD recorder 1 operating as the Source device in the system of the embodiment is provided with a mechanism so as not to make the digital TV apparatus 3b cause the failure in the authentication key exchange processing. It goes without saying that during execution of “MOVE” (movement) to and from the digital TV apparatus 3b, the mechanism does not make the PC 3a cause the failure in the authentication key exchange processing. Hereinafter, the mechanism will be described in detail.

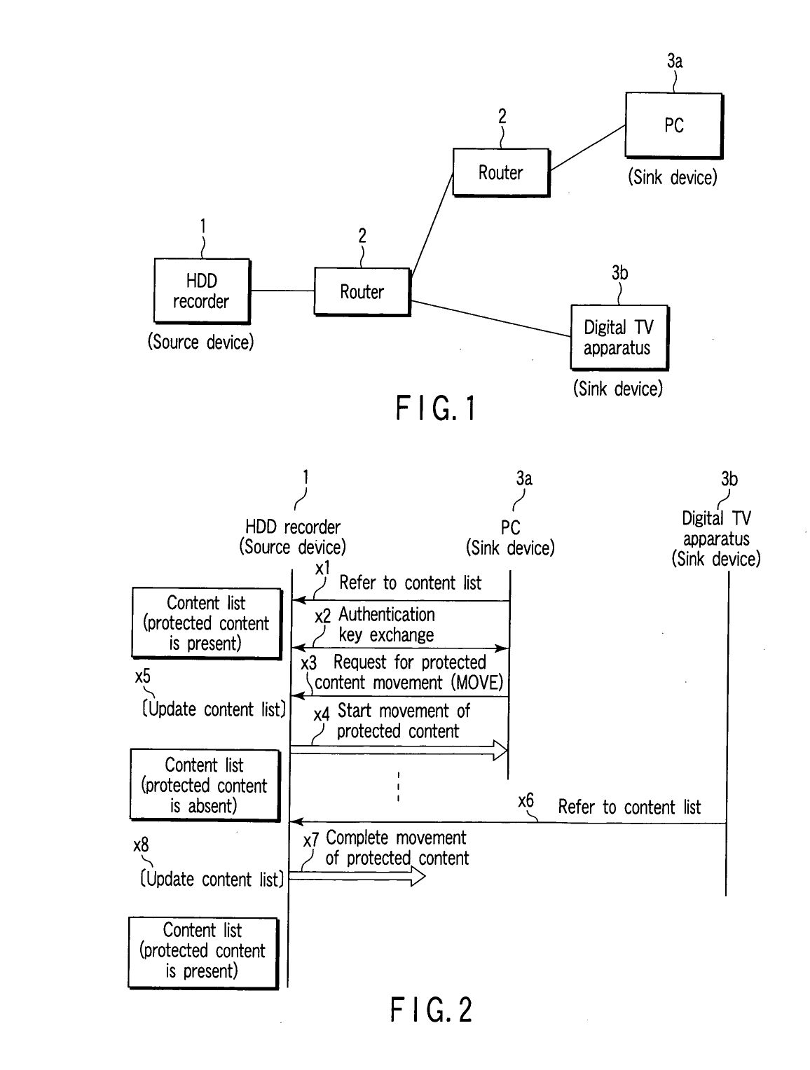

FIG. 2 is a timing chart showing an example of the flow of the operation of the HDD recorder 1, PC 3a and digital TV apparatus 3b. Here, it is supposed that at first, the PC 3a has referred to the content list on the HDD recorder 1 [xl of FIG. 2]. At this moment, the HDD recorder 1 discloses content including copy protected content (protected content) in a list for the PC 3a and the digital TV apparatus 3b. And it is also supposed that the PC 3a, which has referred to the content list including the protected content, becomes to perform “MOVE” (movement) the protected content in the list to its own apparatus.

In this case, the authentication key exchange processing is conducted between the HDD recorder 1 and the PC 3a which result in transmitting and receiving the protected content via the IP network [x2 of FIG. 2], after completing this processing, the PC 3anotifies a request for “MOVE” (movement) of the protected content to the HDD recorder 1 [x3 of FIG. 2].

On the other hand, the HDD recorder 1 which has received the notification, starts a transmission of the requested protected content to the PC 3a while encrypting it by using the authentication keys mutually exchanged to and from the PC 3a [x4 of FIG. 2]. Then, when starting the “MOVE” (movement) of the protected content, the HDD recorder 1 executes update of the content list to be disclosed in addition to prohibit the acceptance of the new authentication key exchange processing [x5 of FIG. 2].

The update of the content list is processing performed by the HDD recorder 1 so as not to make the digital TV apparatus 3b be unsuccessful in the authentication key exchange processing. More specifically, the HDD recorder 1 temporarily deletes the protected content from the list to be disclosed as the content list. In other words, when the digital TV apparatus 3b refers to the content list [x6 of FIG. 2], the system does not occur the authentication key exchange processing itself to prevent the failure of the authentication key exchange processing by bringing the list into a state in which only the copy unprotected content not requiring the authentication key exchange processing is present.

After this, when the “MOVE” (movement) of the protected content completes [x7 of FIG. 2], the HDD recorder 1 re-conducts the update of the content list so as to recover the protected content which has been temporarily deleted [protected content other than protected content which has become an object of “MOVE” (movement)] to the list [x8 of FIG. 2]. Thereby, the user can utilize the protected content though the digital TV apparatus 3b.

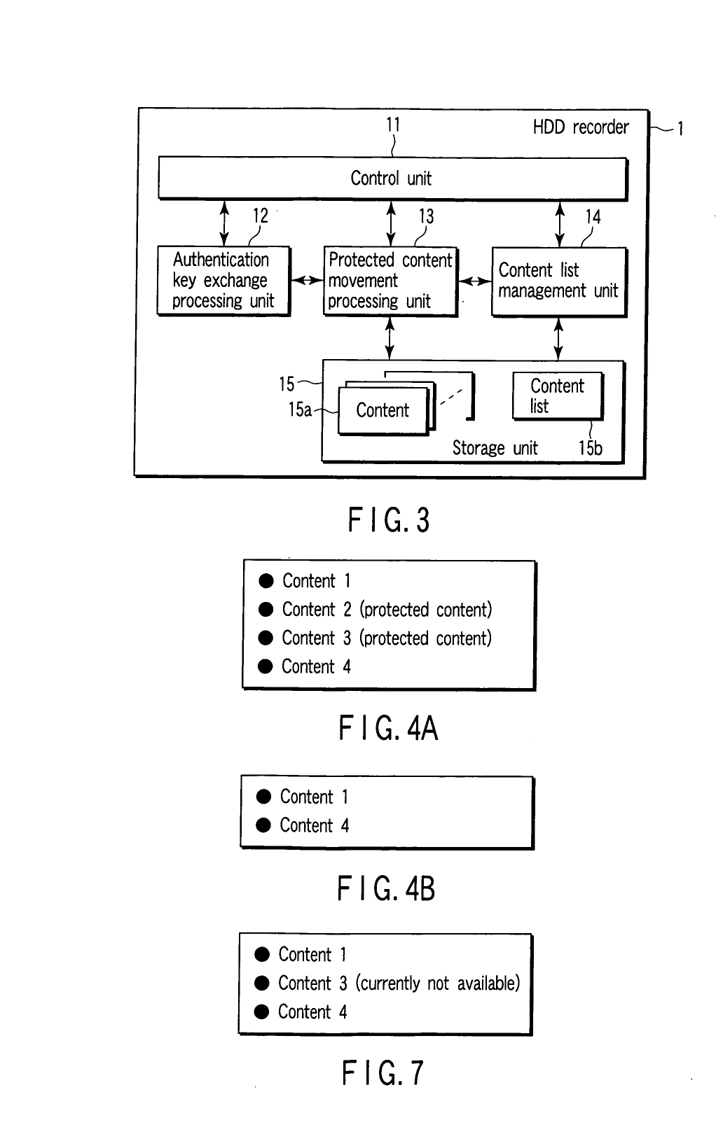

FIG. 3 is a block diagram showing the configuration of the HDD recorder 1 regarding prevention of the authentication processing failure prevention during the “MOVE” (movement). As shown in FIG. 3, the HDD recorder 1 consists of a control unit 11, an authentication key exchange processing unit 12, a protected content movement processing unit 13, a content list management unit 14 and a storage unit 15.

The control unit 11 controls the whole of the HDD recorder 1. The exchange processing unit 12 executes authentication key exchange processing to and from the PC 3a or digital TV apparatus 3b connected via the IP network. The movement processing unit 13 executes “MOVE” (movement) to delete the copyright protected content out of the content stored in the storage unit 15 therefrom as well as transmit them to the PC 3a or the digital TV apparatus 3b. The list management unit 14 temporarily deletes the protected content from the list of the content list stored in the storage unit 15 and updates so as to recover the protected content, which has been deleted, to a table of a content list “15b”. The storage unit 15 is a storage medium with content “15a” and the content list “15b” stored therein. As mentioned above, each content “15a” includes attribute information indicating the presence or absence of the copyright protection.

When starting the “MOVE” (movement) to and from the PC 3a or digital TV apparatus 3b, the movement processing unit 13 notifies the fact to the exchange processing unit 12 and the list management unit 14. The exchange processing unit 12 which has received the notification rejects the reception of the new authentication key exchange processing after the reception of the notification, and the list management unit 14 executes the update of the content list “15b” in order to temporarily delete the protected content “15a” from the list.

Also upon completing the “MOVE” (movement), the movement processing unit 13 notifies the fact to the exchange processing unit 12 and the list management unit 14. The exchange processing unit 12 which has received the notification restarts the reception of the new authentication key exchange processing, and the list management unit 14 re-executes the update of the content list “15b” so as to recover the protected content “15a” which has been temporarily deleted to the list.

Thereby, for instance, the storage unit 15 stores four content of “content 1”, “content 2”, “content 3” and “content 4”. And also if “content 2” and “content 3” among the four content are copyright protected content, the content list to be disclosed for the PC 3a and digital TV apparatus 3b becomes one as shown in FIG. 4A until the “MOVE” (movement) starts, and when the “MOVE” (movement) is started, the content list becomes one as shown in FIG. 4B. Copyright protected “content 2” and “content 3” having been deleted from the content list to be disclosed during the “MOVE” (movement), the system can prevent the authentication key exchange processing from resulting in the failure.

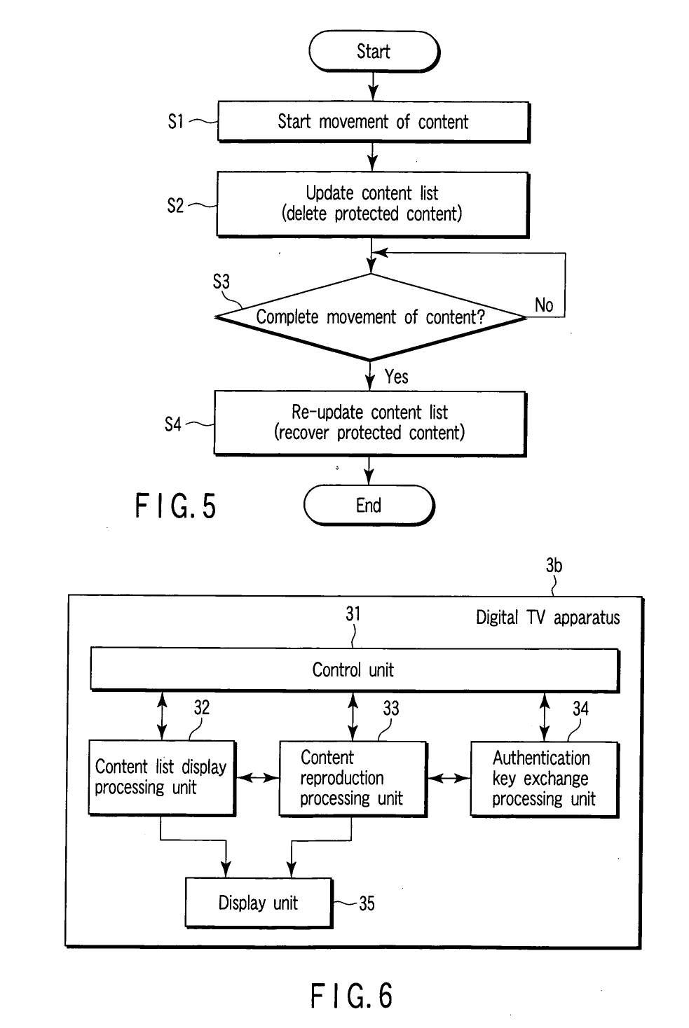

FIG. 5 is a flowchart showing an operation procedure of the HDD recorder 1 operating as the Source device in the system for transmitting and receiving the content regarding the embodiment.

When the HDD recorder 1 starts the “MOVE” (movement) to and from the PC 3a or the digital TV apparatus 3b (block S1), it re-executes updating the content list to recover the protected content, which has been temporarily deleted, to the-list (block S2).

When completing the “MOVE” (movement) (YES, in block S3), the HDD recorder 1 re-executes updating the content list to recover the protected content, which has been temporarily deleted in block S2, to the list (block S4).

Thereby, for instance, during the “MOVE”(movement) to and from the PC 3a, the digital TV apparatus 3b can prevent the authentication key exchange processing from resulting in failure.

Having described an example of deleting the protected content from the table of the content list on the side of the HDD recorder 1 in executing the “MOVE” (movement), as substitute for this, on the side of the HDD recorder 1, for example, adding attribute information indicating the fact of a currently unavailable state is a possible approach. The digital TV apparatus 3b (or PC 3a side) executes display control of the content list on the basis of the attribute information.

FIG. 6 is a block diagram showing the configuration of the digital TV apparatus 3b referring to the content list with the attribute information added thereto. The digital TV apparatus 3b, as shown in FIG. 6, includes a control unit 31, a content list display processing unit 32, a content reproduction processing unit 33, an authentication key exchange processing unit 34 and a display unit 35.

The control unit 31 controls the whole of the digital TV apparatus 3b. The display control unit 32 obtains the content list “15b” from the HDD recorder 1 to display it on the display unit 35. The reproduction processing unit 33 reproduces the content “15a” transferred from the HDD recorder 1 to display it on the display unit 35. The exchange processing unit 34 executes the authentication exchange processing to and from the HDD recorder 1 connected via the IP network. The display unit 35 is, for instance, a display device such as a liquid crystal display (LCD).

In displaying the content list obtained from the HDD recorder 1, for instance, as shown in FIG. 7, the display processing unit 32 notifies the facts that the copyright protected content is currently unavailable on the basis of the added attribute information while presenting the presence of the protected content [other than object of ‘MOVE’ (movement)]. Thereby, the system can make the copyright protected content not to be selected, so that the system prevents the failure in the authentication key exchange processing in a similar way of the foregoing embodiment.

The system may make the display processing unit 32 delete the protected content with the attribute information added thereto from the content list.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A communication apparatus comprising:
a storage unit configured to store content including attribute information indicating presence or absence of copyright protection and a list showing a table of the content;
an authentication key exchange unit configured to mutually obtain authentication keys identifying mutual devices to and from other communication apparatus to authenticate the other communication apparatus;
a protected content movement unit configured to stop reception of new authentication by the exchange unit when copyright protected content is selected from the list, and to encrypt the selected and copyright protected content by using the authentication keys and moving it to the other communication apparatus authenticated by the exchange unit via a network; and
a content list management unit configured to delete the copyright protected content from the table of the list during content movement by the movement unit.

2. The communication apparatus according to claim 1, wherein the management unit recovers the copyright protected content to the list when completing the content movement by the movement unit.

3. The communication apparatus according to claim 1, wherein the network is an Internet Protocol network and is compliant with Digital Transmission Content protection-IP and Digital Living Network Alliance.

4. A system for transmitting and receiving content, comprising a transmitting device and a receiving device transmitting and receiving content via a network, wherein
the transmitting device includes:
a storage unit configured to store content including attribute information indicating presence or absence of copyright protection and a list showing a table of the content;
an authentication key exchange unit configured to mutually obtain authentication keys identifying mutual devices to and from other communication apparatus to authenticate the other communication apparatus;
a protected content movement unit configured to stop a reception of new authentication by the exchange unit when copyright protected content is selected from the list, and to encrypt the selected and copyright protected content by using the authentication keys and moving it to the other communication apparatus authenticated by the exchange unit via the network; and
a content list management unit configured to add management information indicating that the content is currently unavailable to the copyright protected content in the table of the list during content movement by the movement unit, and
the receiving unit includes:
a content list obtaining unit configured to obtain the list stored in the storage unit; and
a content list display unit configured to delete the content with the management information from the table of the list obtained by the obtaining unit, and to display the list after deleting.

5. The system according to claim 4, wherein the display unit displays information indicating that the copyright protected content with the management information is currently unavailable, in the table of the list obtained by the obtaining unit.

6. A method for managing a content list, comprising:
storing content including attribute information indicating presence or absence of copyright protection and a list showing a table of the content;
obtaining mutually authentication keys to identify mutual devices to and from other communication apparatus to authenticate the other communication apparatus;
stopping a reception of new authentication by the exchange means when copyright protected content is selected from the list, encrypting the selected and copyright protected content by using the authentication keys and moving it to the other communication apparatus authenticated by the exchange means via a network; and
deleting the copyright protected content from the table of the list during movement of the copyright protected content.

7. The method according to claim 6, further comprising recovering the copyright protected content to the list when the movement of the copyright protected content is completed.
